(19) United States
(12) Patent Application Publication
(10) Pub. No.: US 2009/0129503 A1
(43) Pub. Date: May 21, 2009

(54) Communication Device, Communication System, and Modulation Method

(75) Inventor: Kumi Sagara, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 11/993,952

(22) PCT Filed: Jun. 28, 2006
(86) PCT No.: PCT/JP2006/312910

§ 371 Date: Dec. 26, 2007

(30) Foreign Application Priority Data
Jun. 29, 2005 (JP) 2005-190638

(51) Int. Cl. H04L 27/20

(52) U.S. Cl. 375/302

(57) ABSTRACT

The following process is eliminated to reduce the processing volume: calculating the amount of phase rotation from a reference signal point stored in the device, and carrying out further rotation so that a signal point is obtained that corresponds to the signal point obtained as a result of calculating the amount of phase rotation by using the signal point having an established timing as a reference signal point. The present invention is characterized in including a phase determining part (57) for determining the phase of an initial signal point so that a signal point having an established timing is brought to a prescribed phase from among signal points obtained when the first bit string is modulated using a differential encoding scheme; a signal point string generator (58) for modulating the first bit string by using the differential encoding scheme on the basis of the initial signal point, and modulating the second bit string by using a absolute phase scheme using the signal point having the established timing as a reference signal point; and a data output part (60) for transmitting the modulated first bit string, and then transmitting the modulated second bit string.

### TECHNICAL FIELD

The present invention relates to a communication device, a communication system, and a modulation method.

### BACKGROUND ART

An absolute phase scheme and a differential encoding scheme are examples of modulation schemes used when data is wirelessly transmitted. The absolute phase scheme is a modulation scheme in which a signal point (reference signal point) having zero phase is determined in advance, and the position of the signal point is expressed by the amount of phase rotation from the reference signal point. 16 QAM is an example of an absolute phase scheme. The differential encoding scheme is a modulation scheme for expressing the phase of a signal point by the phase difference between sequentially received signals. In this scheme, an initial signal point for expressing an initial phase in the lead is necessary, but it is not necessary to determine a reference signal point in advance. An example of a differential encoding scheme is π/4 shift QPSK modulation.

When a receiving communication device receives a symbol string that has been modulated using an absolute phase scheme, the symbols cannot be demodulated if the reference signal point is unknown. In view of this, the following composite modulation scheme is sometimes used in order to transmit the reference signal point to the receiving communication device.

The composite modulation scheme is a hybrid modulation scheme in which the lead portion of a symbol string that constitutes a frame is modulated using the differential encoding scheme, which does not require a reference signal point; and the remainder is modulated using the absolute phase scheme. In the composite modulation scheme, the transmitting communication device designates the final signal point of the signal points obtained by modulation using the differential encoding scheme as the reference signal point, and the symbol string is modulated using the absolute phase scheme. The receiving communication device acquires the final signal point from the signal points modulated using the differential encoding scheme, the final signal point thus acquired is designated as the reference signal point, and the symbol string is demodulated using the absolute phase scheme. In the composite modulation scheme, the reference signal point can thus be transmitted from the transmitting communication device to the receiving communication device by the final signal point of the signal points modulated using the differential encoding scheme.

Patent Document 1 describes a technique whereby 8-PSK signals, QPSK signals, and the like can be demodulated using a simple configuration by a process performed in a receiving communication device.

[Patent Document 1] Japanese Laid-open Patent Application No. 2004-364046

### DISCLOSURE OF THE INVENTION

### Problems to be Solved by the Invention

In the transmitting communication device, when using either the absolute phase scheme or the differential encoding scheme, the reference signal point is stored in the device, and the phase of the symbols is determined according to the amount of phase rotation from the reference signal point. However, in the composite modulation scheme, a signal point having an established timing (for example, the aforementioned final signal point) must be modulated as the reference signal point when modulation is carried out in the transmitting communication device by using the absolute phase scheme. Therefore, a process is carried out by calculating the amount of phase rotation from the reference signal point stored in the device for each symbol, and carrying out further rotation so that a signal point is obtained that corresponds to the signal point obtained as a result of calculating the amount of phase rotation by using the signal point having the established timing as a reference signal point. This processing is extremely involved, and there is a need to reduce the amount of processing.

An object of the present invention is therefore to provide a communication device, a modulation method, and a program in which it is possible to eliminate processing that is carried out by calculating the amount of phase rotation from a reference signal point stored in the device, and carrying out further rotation so that a signal point is obtained that corresponds to the signal point obtained as a result of calculating the amount of phase rotation by using the signal point having an established timing as a reference signal point, and to reduce the processing volume.

Another object of the present invention is to provide a communication device, a communication system, and a modulation method whereby a signal point having a prescribed phase can be transmitted at an established timing in the case of modulation performed using the differential encoding scheme.

### Means for Solving the Problems

A communication device according to the present invention for resolving the abovementioned problems includes first bit string acquisition means for acquiring a first bit string; initial signal point determining means for determining a phase of an initial signal point so that a signal point having an established timing is brought to a prescribed phase from among signal points obtained when the first bit string is modulated using a differential encoding scheme; differential encoding scheme modulating means for modulating the first bit string by using the differential encoding scheme on the basis of the initial signal point; absolute phase scheme modulating means for modulating a second bit string by using an absolute phase scheme using the signal point having the established timing as a reference signal point; and transmission means for transmitting the modulated first bit string, and then transmitting the modulated second bit string.

Accordingly, it is possible to always obtain the prescribed phase in a signal point having the established timing that is included in a signal point string obtained by modulating the first bit string by using the differential encoding scheme, which is a modulation scheme for expressing the phase of a symbol by the phase difference between sequentially received signals. Therefore, modulation is carried out using this signal point that always has the prescribed phase as the reference signal point in the absolute phase scheme, which is a modulation scheme in which a signal point assumed to have zero phase (reference signal point) is determined in advance, and the position of the signal point is expressed by the amount of phase rotation from the reference signal point. As a result, it is possible to eliminate processing that is carried out in the communication device by calculating the amount of phase rotation from the reference signal point held in the device, and carrying out further rotation so that a signal point is obtained that corresponds to the signal point obtained as a result of calculating the amount of phase rotation by using the signal point having the established timing as the reference signal point. Specifically, it is possible to reduce the amount of processing in the communication device.

In the communication device, the initial signal point determining means may include storage means for storing phases associated with bit strings; and reading means for reading the phase stored by the storage means in association with a bit string that corresponds to the first bit string; and the initial signal point determining means may determine the read phase to be the phase of the initial signal point.

The communication device can thereby determine the phase of the initial signal point so that the signal point having the established timing has the prescribed phase, without carrying out modulation.

In the communication device described above, the bit string stored by the storage means may be a bit string having a prescribed length; and the reading means may read the phase stored by the storage means in association with the bit string having the prescribed length included at a prescribed position in the first bit string.

A communication system according to the present invention includes a transmitting communication device having first bit string acquisition means for acquiring a first bit string; initial signal point determining means for determining a phase of an initial signal point so that a signal point having an established timing is brought to a prescribed phase from among signal points obtained when the first bit string is modulated using a differential encoding scheme; differential encoding scheme modulating means for modulating the first bit string by using the differential encoding scheme on the basis of the initial signal point; absolute phase scheme modulating means for modulating a second bit string by using an absolute phase scheme using the signal point having the established timing as a reference signal point; and transmission means for transmitting the modulated first bit string, and then transmitting the modulated second bit string; and a receiving communication device having receiving means for receiving the modulated first and second bit strings; and demodulating means for demodulating the modulated second bit string using the signal point having the established timing as the reference signal point among the signal points that constitute the modulated first bit string.

A communication device according to another aspect of the present invention includes bit string acquisition means for acquiring a bit string; initial signal point determining means for determining a phase of an initial signal point so that a signal point having an established timing is brought to a prescribed phase from among signal points obtained when the bit string is modulated using a differential encoding scheme; differential encoding scheme modulating means for modulating the bit string by using the differential encoding scheme on the basis of the initial signal point; and transmission means for transmitting the modulated bit string.

The phase of the initial signal point is thereby determined so that a signal point having the established timing is brought to the prescribed phase in the case that the bit string is modulated using the differential encoding scheme. Therefore, the communication device can transmit a signal point having the prescribed phase at the established timing in cases where modulation is carried out using the differential encoding scheme.

A modulation method according to the present invention includes a bit string acquisition step of acquiring a bit string; an initial signal point determining step of determining a phase of an initial signal point so that a signal point having an established timing is brought to a prescribed phase from among signal points obtained when the bit string is modulated using a differential encoding scheme; a differential encoding modulating step of modulating the bit string by using the differential encoding scheme on the basis of the initial signal point; and a transmission step of transmitting the modulated bit string.

A program according to the present invention causes a computer to function as bit string acquisition means for acquiring a bit string; initial signal point determining means for determining a phase of an initial signal point so that a signal point having an established timing is brought to a prescribed phase from among signal points obtained when the bit string is modulated using a differential encoding scheme; differential encoding scheme modulating means for modulating the bit string by using the differential encoding scheme on the basis of the initial signal point; and transmission means for transmitting the modulated bit string.

### BRIEF DESCRIPTION OF THE DRAWINGS

FIG. 1 is a block diagram of a mobile communication system according to an embodiment of the present invention;

FIG. 2 is a system block diagram of a base station device according to the embodiments of the present invention;

FIG. 3 is a system block diagram of a mobile station device according to the embodiments of the present invention;

FIG. 4 is a signal point layout diagram of a differential encoding scheme according to the embodiments of the present invention;

FIG. 5 is a signal point layout diagram of an absolute phase scheme according to the embodiments of the present invention;

FIG. 6 is an explanatory diagram of composite modulation according to the embodiments of the present invention;

FIG. 7 is an explanatory diagram of composite modulation according to the embodiments of the present invention;

FIG. 8 is a system block diagram of the base station device according to the embodiments of the present invention; and

FIG. 9 is a process flowchart of the base station device according to the embodiments of the present invention.

### BEST MODE FOR CARRYING OUT THE INVENTION

Embodiments of the present invention will be described with reference to the drawings.

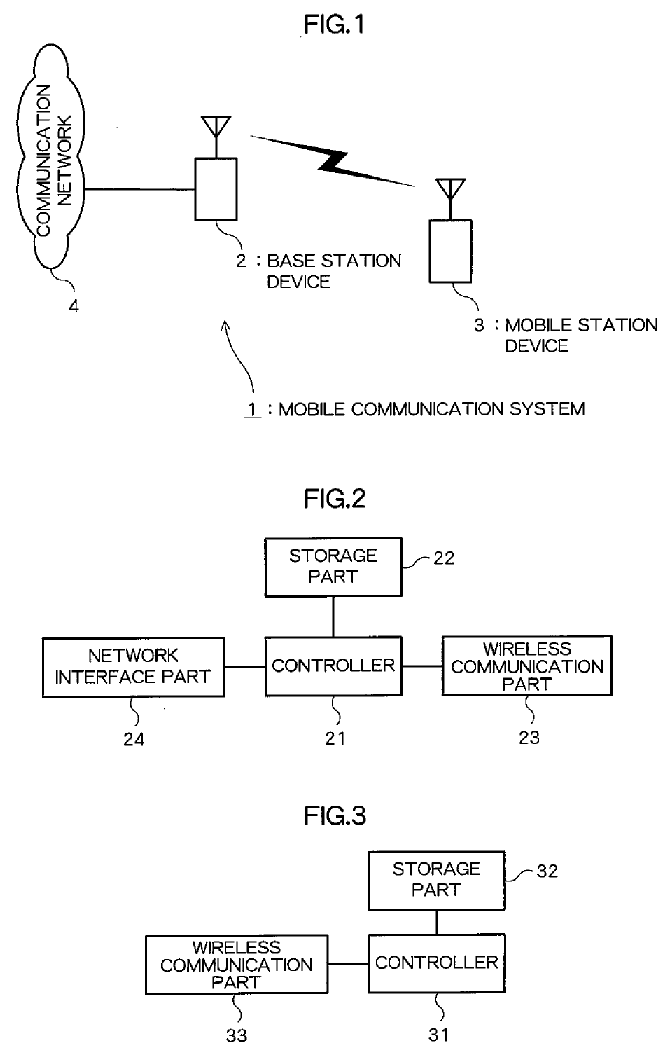

FIG. 1 is a block diagram of a mobile communication system 1 according to the present embodiment. As shown in this diagram, the mobile communication system 1 according to the present embodiment includes a base station device 2, a mobile station device 3, and a communication network 4. The base station device 2 communicates simultaneously with a plurality of mobile station devices 3, and relays communication carried out between the mobile station devices 3 and the communication network 4.

In the communication between the base station device 2 and the mobile station device 3, the lead portion of a symbol string that constitutes a frame is modulated using a differential encoding scheme, which does not require a reference signal point; and the remaining portion is modulated using an absolute phase scheme. In the present specification, this type of modulation scheme is referred to as a composite modulation scheme.

As shown in FIG. 2, the base station device 2 has a controller 21, a storage part 22, a wireless communication part 23, and a network interface part 24.

The controller 21 controls the components of the base station device 2 and executes processing related to telephone calls, data communication and the like. The controller 21 divides communication data into frames having a prescribed length, and outputs the divided communication data by the frame to the wireless communication part 23. The controller 21 also modulates and demodulates the communication data by using the composite modulation scheme.

The storage part 22 acts as working memory for the controller 21. The storage part 22 also holds programs and parameters related to various processes carried out by the controller 21. The storage part 22 also stores an initial signal point phase storage table (described below) that is used during modulation and demodulation carried out by the controller 21. The storage part 22 also holds a reference signal point (zero phase) that is referenced during modulation.

The wireless communication part 23 has an antenna, and carries out processing in which frame-divided communication data transmitted from the mobile station device 3 is received, subjected to frequency conversion, and output to the controller 21. The wireless communication part 23 further carries out processing in which the frame-divided communication data input from the controller 21 is subjected to frequency conversion and is output via the antenna according to instructions input from the controller 21.

The network interface part 24 is connected to the communication network 4, and carries out processing in which the communication data transmitted from the communication network 4 is received and output to the controller 21. The network interface part 24 also transmits the communication data to the communication network 4 according to instructions from the controller 21.

The mobile station device 3 includes a controller 31, a storage part 32, and a wireless communication part 33, as shown in FIG. 3.

The controller 31 controls the components of the mobile station device 3 and executes processing related to telephone calls, data communication and the like. The controller 31 divides communication data into frames having a prescribed length, and outputs the divided communication data by the frame to the wireless communication part 33. The controller 31 also modulates and demodulates the communication data by using the composite modulation scheme.

The storage part 32 acts as working memory for the controller 31. The storage part 32 also holds programs and parameters related to various processes performed by the controller 31. The storage part 32 also stores an initial signal point phase storage table (described below) that is used during modulation and demodulation carried out by the controller 31. The storage part 32 also holds a reference signal point (zero phase) that is referenced during modulation.

The wireless communication part 33 has an antenna, and carries out processing in which frame-divided communication data transmitted from the base station device 2 is received, subjected to frequency conversion, and output to the controller 31. The wireless communication part 33 further carries out processing in which the frame-divided communication data inputted from the controller 31 is subjected to frequency conversion and is output via the antenna according to instructions inputted from the controller 31.

In the present embodiment, both the base station device 2 and the mobile station device 3 transmit communication data that has been divided into frames by modulation using the composite modulation scheme, and carry out demodulation by using the composite modulation scheme. Since the processes in both devices are similar, a case will be described below in which communication data is transmitted from the base station device 2.

First, the differential encoding scheme and the absolute phase scheme will be briefly described.

In the differential encoding scheme, signals are composed of signal point strings. The differential encoding scheme is a modulation scheme for expressing a symbol by the phase difference between sequentially received signal points.

A symbol is obtained when bits included in a bit string that constitutes communication data are grouped together in the number of modulation units. Specifically, two bits equal one symbol in, e.g., a modulation scheme in which the number of modulation units is two bits, i.e., in which two bits can be expressed by one signal.

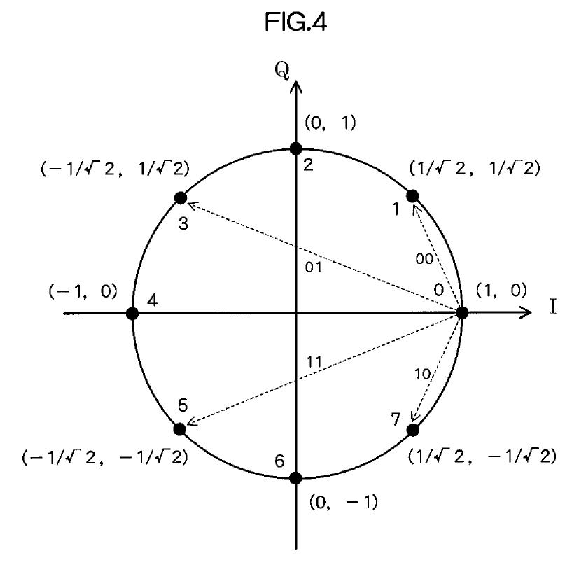

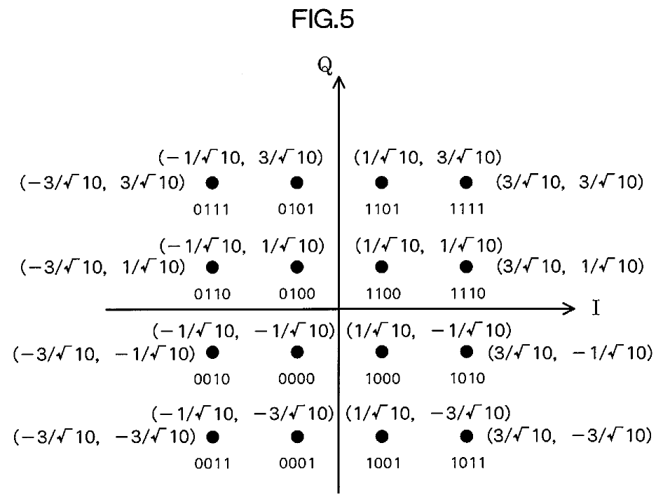

FIG. 4 is a signal point layout diagram of π/4 shift QPSK, which is an example of the differential encoding scheme. The number of modulation units in π/4 shift QPSK is two bits.

In the differential encoding scheme, an initial signal point is required when modulating a symbol string. Specifically, in the differential encoding scheme, a symbol is expressed by the difference between signal points, and it is therefore necessary to determine the position of the initial signal point (referred to as the “initial signal point”). In FIG. 4, the phase of the signal point corresponding to the first symbol is obtained by adding π/4, 3π/4, 5π/4, or 7π/4 to the phase of the initial signal point in accordance with the content of the first symbol, where the phase of the initial signal point is 0 (coordinates: (1,0)). These correspond to cases in which the first symbol is 00, 01, 10, or 11, respectively.

The phase of the signal point corresponding to the second symbol is obtained by adding π/4, 3π/4, 5π/4, or 7π/4 to the phase of the signal point that corresponds to the first symbol in accordance with the content of the second symbol. These correspond to cases in which the second symbol is 00, 01, 10, or 11, respectively.

In the differential encoding scheme, the phase difference between the signal points thus corresponds to the symbols. Therefore, in the mobile station device 3 that receives communication signals, demodulation can be carried out by merely acquiring the phase difference between the signal points, even in cases where the phase of the communication signals has been rotated by the Doppler effect, fading, or the like.

In the absolute phase scheme, however, signals are composed of signal point strings. The absolute phase scheme is a modulation scheme in which a signal point (reference signal point) having zero phase is determined in advance, and symbols are expressed by the amount of change in the phase and amplitude of the signal points in relation to the reference signal point.

FIG. 5 is a signal point layout diagram of 16 QAM, which is an example of the absolute phase scheme. The number of modulation units in 16 QAM is 4 bits.

The above-mentioned reference signal point is required in the absolute phase scheme. In FIG. 5, the reference signal point is assumed to be a point on the I axis (e.g., coordinates: (1, 0)). In this case, the coordinates of a signal point of the symbol “0000” are determined to be (−1/√10, −1/√10); and the coordinates of the symbol “1101” are determined to be (1/√10, 3/√10). For example, when the reference signal point is assumed to be another point on the I axis (e.g., coordinates: (−1, 0)), the coordinates of signal point of the symbol “0000” are determined to be (1/√10, 1/√10); and the coordinates of the symbol “1101” are determined to be (−1/√10, −3/√10). In other words, the coordinates of the signal points of the symbols are determined by the amount of change in the phase and amplitude in relation to that of the reference signal point.

Thus, in the absolute phase scheme, signal points determined based on the reference signal point thus express symbols, and the symbols cannot be identified if the reference signal point is not known in the mobile station device 3 that receives communication signals.

In this regard, the Doppler effect, fading, or the like may occur in wireless communication as described above, and it is therefore difficult to acquire the absolute relationship of the signal point and the phase. In view of this, in the composite modulation scheme, part of the lead portion of the frame is first modulated using the differential encoding scheme, which does not require a reference signal point; and a signal point having an established timing (referred to herein as “final signal point”) in the signal point string modulated using the differential encoding scheme is used as the reference signal point in the absolute phase scheme. The remaining portion of the frame is modulated using the absolute phase scheme, using the reference signal point thus determined.

In the present embodiment, the phase of the final signal point in the signal point string modulated using the differential encoding scheme is necessarily set to a prescribed phase (zero phase in the present embodiment). An overview of the modulation processing used for this purpose will be described first, and a detailed description thereof will follow.

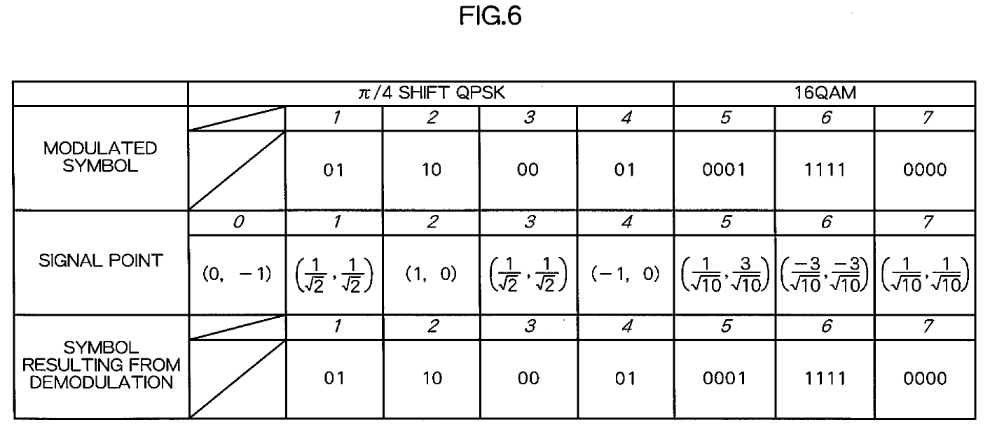

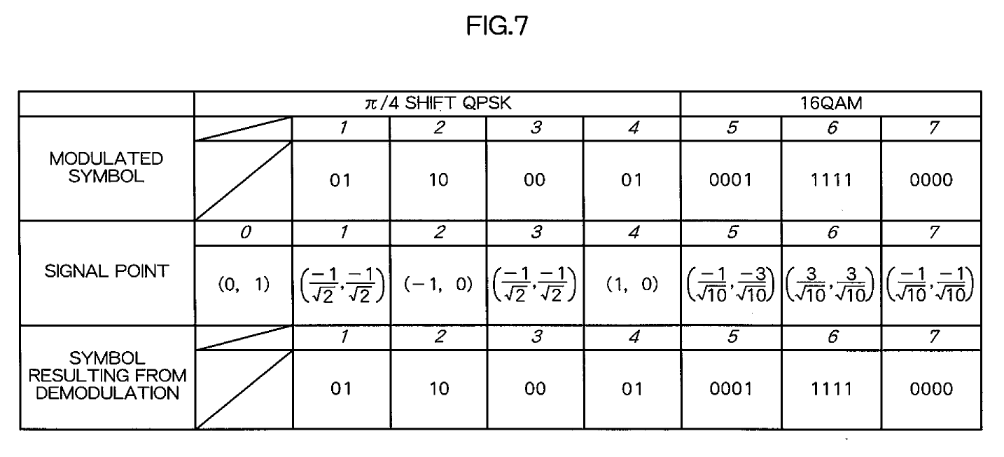

FIGS. 6 and 7 are explanatory diagrams of the manner in which communication data is modulated using the composite modulation scheme in the base station device 2. In FIGS. 6 and 7, the modulated symbols are shown as being the same, while the initial signal points of differential encoding scheme (π/4 shift QPSK) are different. Since the initial signal points are different, the coordinates of the final signal point in the differential encoding scheme are different in FIGS. 6 and 7. The coordinates of the final signal point are thus varied according to the phase of the initial signal point.

In view of this, the base station device 2 sets the phase of the initial signal point in accordance with the content of modulated symbols in the portion modulated using the differential encoding scheme so that the coordinates of the final signal point always correspond to zero phase (the state shown in FIG. 7). This process for setting the phase of the initial signal point will be described in detail below.

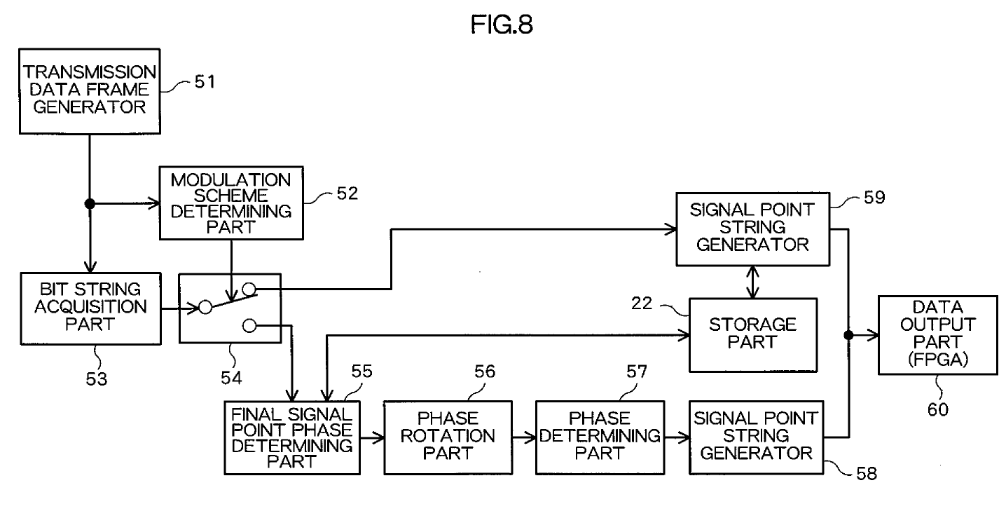

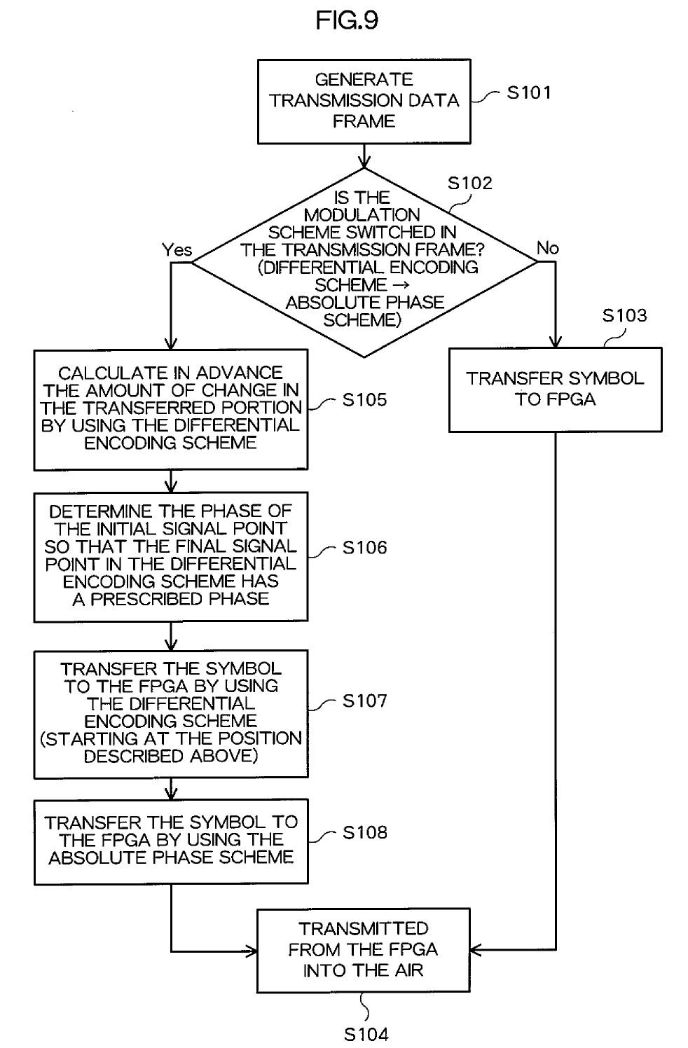

FIG. 8 is a diagram showing a functional block of the base station device 2. FIG. 9 is process flowchart of the base station device 2. As shown in FIG. 8, in functional terms, the controller 21 and wireless communication part 23 of the base station device 2 include a transmission data frame generator 51, a modulation scheme determining part 52, a bit string acquisition part 53, a switch 54, a final signal point phase determining part 55, a phase rotation part 56, a phase determining part 57, a signal point string generator 58, a signal point string generator 59, and a data output part 60.

First, the transmission data frame generator 51 acquires data to be transmitted for each frame, and generates transmission data frames (S101). The transmission data frames thus generated are output to the bit string acquisition part 53. The bit string acquisition part 53 acquires the inputted transmission data frames as a bit string.

The modulation scheme determining part 52 determines whether or not the composite scheme modulation is carried out, and switches the switch 54 according to the determination results (S102). In the case that the modulation scheme determining part 52 determines that composite scheme modulation will not be carried out, the bit string outputted by the bit string acquisition part 53 is inputted to the signal point string generator 59 as a result of the switching. Conversely, in the case that the modulation scheme determining part 52 determines that composite scheme modulation will be carried out, the bit string outputted by the bit string acquisition part 53 is inputted to the final signal point phase determining part 55.

The signal point string generator 59 modulates the inputted bit string using the absolute phase scheme, in which the reference signal point is assumed to be the reference signal point held in the storage part 22. The signal point string generator 59 outputs the signal point string, which is a result of the modulation, to the data output part 60 (S103). The data output part 60 has an FPGA (Field Programmable Gate Array) for performing high-speed signal processing, and converts the inputted signal point string to radio signals, and sends the radio signals into a radio section (air) from the antenna provided to the wireless communication part 23 (S104).

Prior to modulation, the final signal point phase determining part 55, the phase rotation part 56, and the phase determining part 57 calculate the amount of change (amount of phase rotation when modulated) in the portion of the inputted bit string to be modulated using the differential encoding scheme (portion modulated using the differential encoding scheme) (S105). The phase of the initial signal point is determined so that the final signal point in the differential encoding scheme has the prescribed phase (106). This processing will be described in detail below.

The final signal point phase determining part 55 acquires the prescribed phase that is designed to serve as the phase of the final signal point. This phase may be stored in the storage part 22, or the final signal point phase determining part 55 can definitively set the phase of the final signal point to zero phase using the circuit structure.

The phase rotation part 56 first acquires a bit string that is a portion modulated using the differential encoding scheme. Then the phase rotation part 56 sets the phase of the final signal point to the prescribed phase determined by the final signal point phase determining part 55, and rotates the phase in reverse, starting from the back of the bit string, according to the content thereof using π/4 shift QPSK.

The phase determining part 57 determines the phase of the initial signal point, and outputs the results to the signal point string generator 58. Specifically, the phase determining part 57 acquires the phase of the initial signal point that is obtained as a result of reverse rotation performed by the phase rotation part 56.

The phase of the initial signal point can thus be determined as a result of the phase rotation part 56 rotating the bit string in reverse. The phase of the initial signal point can also be determined so that the phase of the final signal point is the prescribed phase, on the basis of the inputted bit string and the initial signal point phase storage table stored in the storage part 22. An example of this will be given below.

Table 1 is one example of the initial signal point phase storage table. In Table 1, a header portion of a traffic channel (TCH) of a mobile communication system is shown as the portion modulated using the differential encoding scheme.

TABLE 1

| | | | | | PHASE OF |
|---|---|---|---|---|---|
| PORTION THAT IS MODULATED USING | | | | | THE INITIAL |
| THE DIFFERENTIAL ENCODING SCHEME | | | | | SIGNAL |
| R | SS | PR | UW | MI | POINT |
| 0000 | 01 | 10011001100100110011001 | 0011110101001100 | 00000000 | 3π/4 |
| 0000 | 01 | 10011001100100110011001 | 0011110101001100 | 00000001 | π/4 |
| 0000 | 01 | 10011001100100110011001 | 0011110101001100 | 00000010 | 5π/4 |
| 0000 | 01 | 10011001100100110011001 | 0011110101001100 | 00000011 | 7π/4 |
| . . . | . . . | . . . | . . . | . . . | . . . |

As shown in Table 1, the initial signal point phase storage table stores the phases of the initial signal point corresponding to the content of the portion modulated using the differential encoding scheme. The phase of the initial signal point is set so that the phase of the final signal point is always zero when a portion modulated using the differential encoding scheme is modulated using π/4 shift QPSK using the initial signal point selected as described above.

The phase determining part 57 may thus read the phase of the initial signal point that is stored in correspondence with the inputted bit string, and set this phase as the phase of the initial signal point. In this case, the final signal point phase determining part 55 and the phase rotation part 56 are unnecessary.

The signal point string generator 58 modulates a bit string by using the composite modulation scheme in which the phase of the initial signal point is assumed to be the phase inputted from the phase determining part 57. A signal point string is thereby generated and outputted to the data output part 60 (S107, S108). In the outputted signal point string, the reference signal point of the absolute phase scheme always has the prescribed phase determined by the final signal point phase determining part 55. The data output part 60 converts the inputted signal point string into radio signals by using the FPGA described above, and sends the radio signals into the radio section (air) from the antenna provided to the wireless communication part 23 (S104).

The mobile station device 3 that receives the thus modulated bit string demodulates the portion modulated using the absolute phase scheme using the final signal point as the reference signal point among the signal points that constitute the portion modulated using the differential encoding scheme.

As described above, the base station device 2 carries out processing in order to set the phase of the initial signal point. Accordingly, it is possible to always obtain the prescribed phase in a signal point having the established timing (final signal point) that is included in a signal point string obtained by modulating the portion modulated using the differential encoding scheme (first bit string) by using the differential encoding scheme. Therefore, in the portion modulated using the absolute phase modulation scheme (second bit string), modulation is carried out using a signal point that always has the prescribed phase as the reference signal point. It is therefore possible to eliminate processing that is carried out by calculating the amount of phase rotation from the reference signal point stored in the storage part 22, and carrying out further rotation so that a signal point is obtained that corresponds to the signal point obtained as a result of calculating the amount of phase rotation by using the signal point having an established timing as a reference signal point. It is thereby possible to reduce the processing volume.

When the initial signal point phase storage table is used, it is also possible to determine the phase of the initial signal point so that the signal point having the established timing has the prescribed phase, without modulation actually being carried out in advance.

The phase of the initial signal point is determined so that a signal point having the established timing is brought to the prescribed phase in the case that the bit string is modulated using the differential encoding scheme. It is therefore possible to transmit a signal point having the prescribed phase at the established timing in cases where modulation is carried out using the differential encoding scheme.

The present invention is not limited to the abovementioned embodiments. For example, a case was described in the abovementioned embodiments in which the present invention is applied to a mobile communication system. However, the present invention can be applied to any communication system that uses the composite modulation scheme.

1. A communication device, comprising:
first bit string acquisition means for acquiring a first bit string;
initial signal point determining means for determining a phase of an initial signal point so that a signal point having an established timing is brought to a prescribed phase from among signal points obtained when the first bit string is modulated using a differential encoding scheme;
differential encoding scheme modulating means for modulating the first bit string by using the differential encoding scheme on the basis of the initial signal point;
absolute phase scheme modulating means for modulating a second bit string by using an absolute phase scheme using the signal point having the established timing as a reference signal point; and
transmission means for transmitting the modulated first bit string, and then transmitting the modulated second bit string.

2. The communication device of claim 1, wherein the initial signal point determining means comprises:
storage means for storing phases associated with bit strings; and
reading means for reading the phase stored by the storage means in association with a bit string that corresponds to the first bit string; wherein
the initial signal point determining means determines the read phase to be the phase of the initial signal point.

3. The communication device of claim 2, wherein:
the bit string stored by the storage means is a bit string having a prescribed length; and
the reading means reads the phase stored by the storage means in association with the bit string having the prescribed length included at a prescribed position in the first bit string.

4. A communication system, comprising:
a transmitting communication device having first bit string acquisition means for acquiring a first bit string; initial signal point determining means for determining a phase of an initial signal point so that a signal point having an established timing is brought to a prescribed phase from among signal points obtained when the first bit string is modulated using a differential encoding scheme; differential encoding scheme modulating means for modulating the first bit string by using the differential encoding scheme on the basis of the initial signal point; absolute phase scheme modulating means for modulating a second bit string by using an absolute phase scheme using the signal point having the established timing as a reference signal point; and transmission means for transmitting the modulated first bit string, and then transmitting the modulated second bit string; and
a receiving communication device having receiving means for receiving the modulated first and second bit strings; and demodulating means for demodulating the modulated second bit string using the signal point having the established timing as the reference signal point among the signal points that constitute the modulated first bit string.

5. A communication device, comprising:
bit string acquisition means for acquiring a bit string;
initial signal point determining means for determining a phase of an initial signal point so that a signal point having an established timing is brought to a prescribed phase from among signal points obtained when the bit string is modulated using a differential encoding scheme;
differential encoding scheme modulating means for modulating the bit string by using the differential encoding scheme on the basis of the initial signal point; and
transmission means for transmitting the modulated bit string.

6. A modulation method, comprising:
a bit string acquisition step of acquiring a bit string;
an initial signal point determining step of determining a phase of an initial signal point so that a signal point having an established timing is brought to a prescribed phase from among signal points obtained when the bit string is modulated using a differential encoding scheme;
a differential encoding modulating step of modulating the bit string by using the differential encoding scheme on the basis of the initial signal point; and
a transmission step of transmitting the modulated bit string.
